(19) United States
(12) Patent Application Publication
(10) Pub. No.: US 2024/0100616 A1
(43) Pub. Date: Mar. 28, 2024

(54) APPARATUS AND METHOD FOR CONTROLLING A JOINING PROCESS

(71) Applicant: David Timmons, Toledo, OH (US)

(72) Inventor: David Timmons, Toledo, OH (US)

(21) Appl. No.: 18/475,708

(22) Filed: Sep. 27, 2023

Related U.S. Application Data
(60) Provisional application No. 63/377,255, filed on Sep. 27, 2022.

(51) Int. Cl. B23K 9/095; B23K 9/23

(52) U.S. Cl. CPC B23K 9/0956; B23K 9/23

(57) ABSTRACT

An apparatus and method for controlling a process used to join together a plurality of workpieces. The apparatus is configured to selectively operate in a “closed” first mode and an “open” second mode based upon a correctness and/or acceptability of the workpieces. When the apparatus is in the “closed” first mode, a flow of electrical current through the electrical path from the electrical source to the electrical destination is permitted. As such, a joining system is enabled, resulting in a joining together of the workpieces. In the “open” second mode of the apparatus, there is an open circuit, which disrupts an electrical continuity and prevents the flow of the electrical current through the electrical path from the electrical source to the electrical destination, and thereby disables the joining system.

### CROSS-REFERENCE TO RELATED APPLICATION

This application claims the benefit of U.S. Provisional Patent Application Ser. No. 63/377,255, filed Sep. 27, 2022, the entirety of which is herein incorporated by reference.

### FIELD

The disclosure relates to a joining process, and more particularly to an apparatus and method for controlling a joining process.

### BACKGROUND

Conventional joining processes such as welding, brazing, bonding, riveting, clinching, and fastening, use different forms of energy to join together workpieces that were previously separated. Welding, in particular, is a permanent joining process that joins workpieces produced from materials, usually metals or thermoplastics, by using high heat to melt the parts together and allowing them to cool, causing fusion. Oftentimes, an additional material, also known as a filler material, is added during the heating process to help bond the two workpieces together.

Various types of welding process are known and used. One such type of welding process is gas metal arc welding, sometimes referred to by its subtypes, as metal inert gas (MIG) welding and tungsten inert gas (TIG) welding. Both MIG and TIG welding uses an arc of electricity to create a short circuit between a continuously fed anode (+ welding tool) and a cathode (− workpieces being welded). Heat produced by the short circuit, along with a non-reactive (hence inert) gas locally melts a material of the workpieces and allows them to mix together. Once the heat is removed, the materials begin to cool and solidify, and fuse the workpieces together.

Such MIG and TIG welding are compatible with a variety of types of consumables, and any operator may generally operate any given MIG and TIG welding system as desired. Drawbacks of traditional welding systems, however, are that the operator may not properly identify which workpieces are intended for joining or defective workpieces, thereby creating problems and additional work.

Accordingly, there exists a need for an apparatus and method for controlling a joining process to overcome such drawbacks with traditional systems.

### SUMMARY

In concordance and agreement with the presently described subject matter, an apparatus and method for controlling a joining process, which minimizes defects and maximizes efficiency and productivity, has surprisingly been discovered.

In one embodiment, an apparatus for controlling a joining process, comprises: a casing; and a control assembly disposed in the casing, wherein the control assembly includes a controller in communication with at least one sensor configured to sense at least one workpiece, wherein the controller is configured to selectively control a joining system based upon at least one workpiece.

As aspects of some embodiments, the apparatus is in a first mode and the joining system is enabled when the at least one workpiece is acceptable and is in a second mode and the joining system is disabled when the at least one workpiece is unacceptable.

As aspects of some embodiments, the joining system is a gas metal arc welding system.

As aspects of some embodiments, the joining system is a portable.

As aspects of some embodiments, the control assembly further includes a first connector and a second connector, the first connector in electrical communication with the controller and an electrical source and the second connector in electrical communication with the controller and an electrical destination.

As aspects of some embodiments, the controller is configured to generate an alert when the at least one workpiece is unacceptable.

As aspects of some embodiments, the controller includes at least one processor, the processor configured to receive at least one signal representative of the at least one workpiece.

As aspects of some embodiments, the at least one signal is transmitted to the at least one processor by at least one transmitter in communication with the at least one sensor.

As aspects of some embodiments, the processor determines an acceptability of the at least one workpiece.

In another embodiment, a method for controlling a joining process, comprises: providing an apparatus including a casing and a control assembly, wherein the control assembly is in communication with at least one sensor and at least one transmitter; sensing, via the at least one sensor, at least one workpiece; transmitting, via the at least one transmitter, at least one signal representative of the at least one workpiece; receiving the at least one signal from the at least one sensor; determining an acceptability of the at least one workpiece; and selectively controlling a joining system based upon the acceptability of the at least one workpiece.

As aspects of some embodiments, the apparatus is in a first mode and the joining system is enabled when the at least one workpiece is acceptable and is in a second mode and the joining system is disabled when the at least one workpiece is unacceptable.

As aspects of some embodiments, the joining system is a gas metal arc welding system.

As aspects of some embodiments, the joining system is a portable.

As aspects of some embodiments, the control assembly further includes a first connector and a second connector, the first connector in electrical communication with the controller and an electrical source and the second connector in electrical communication with the controller and an electrical destination.

As aspects of some embodiments, the controller is configured to generate an alert when the at least one workpiece is unacceptable.

As aspects of some embodiments, the controller includes at least one processor, the processor configured to receive the at least one signal representative of the at least one workpiece.

As aspects of some embodiments, the at least one signal is transmitted to the at least one processor by at least one transmitter in communication with the at least one sensor.

As aspects of some embodiments, the processor determines the acceptability of the at least one workpiece.

In yet another embodiment, a method of controlling a joining of workpieces, comprises: providing an apparatus for controlling a gas metal arc welding system; and selectively enabling and/or disabling the gas metal arc welding system using the apparatus, wherein the apparatus is configured to determine whether the workpieces are acceptable before a joining process.

As aspects of some embodiments, the method further comprises generating an alert when at least one of the workpieces is unacceptable.

Further areas of applicability will become apparent from the description provided herein. The description and specific examples in this summary are intended for purposes of illustration only and are not intended to limit the scope of the present disclosure.

### BRIEF DESCRIPTION OF DRAWINGS

The drawings described herein are for illustrative purposes only of selected embodiments and not all possible implementations, and are not intended to limit the scope of the present disclosure.

FIG. 1 is a schematic side perspective view of an apparatus for controlling a joining process according to an embodiment of the presently disclosed subject matter;

FIG. 2 is a schematic front elevational view of the apparatus of FIG. 1;

FIG. 3 is a schematic top plan view of the apparatus of FIGS. 1 and 2, wherein a casing is not shown;

FIG. 4 is a schematic top perspective view of the apparatus of FIGS. 1-3, wherein the casing is not shown;

FIG. 5 is a schematic view of the apparatus of FIGS. 1-4 in an exemplary application of use;

FIG. 6 is a schematic side perspective view of a gas metal arc welding system including the apparatus of FIGS. 1-4;

FIG. 7 is a schematic front elevational view of the gas metal arc welding system of FIG. 6; and

FIG. 8 is a flow diagram illustrating a method for controlling a joining process using the system of FIGS. 6 and 7 including the apparatus of FIGS. 1-4.

### DETAILED DESCRIPTION

The following description of technology is merely exemplary in nature of the subject matter, manufacture and use of one or more present disclosures, and is not intended to limit the scope, application, or uses of any specific present disclosure claimed in this application or in such other applications as may be filed claiming priority to this application, or patents issuing therefrom. Regarding methods disclosed, the order of the steps presented is exemplary in nature, and thus, the order of the steps may be different in various embodiments. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

All documents, including patents, patent applications, and scientific literature cited in this detailed description are incorporated herein by reference, unless otherwise expressly indicated. Where any conflict or ambiguity may exist between a document incorporated by reference and this detailed description, the present detailed description controls.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

As referred to herein, all compositional percentages are by weight of the total composition, unless otherwise specified. Disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9,1-8,1-3,1-2,2-10,2-8,2-3,3-10,3-9, and so on.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” may encompass both an orientation of above and below. The device may be otherwise oriented (rotated 90 degrees or at other orientations) and the spatially relative descriptors used herein interpreted accordingly.

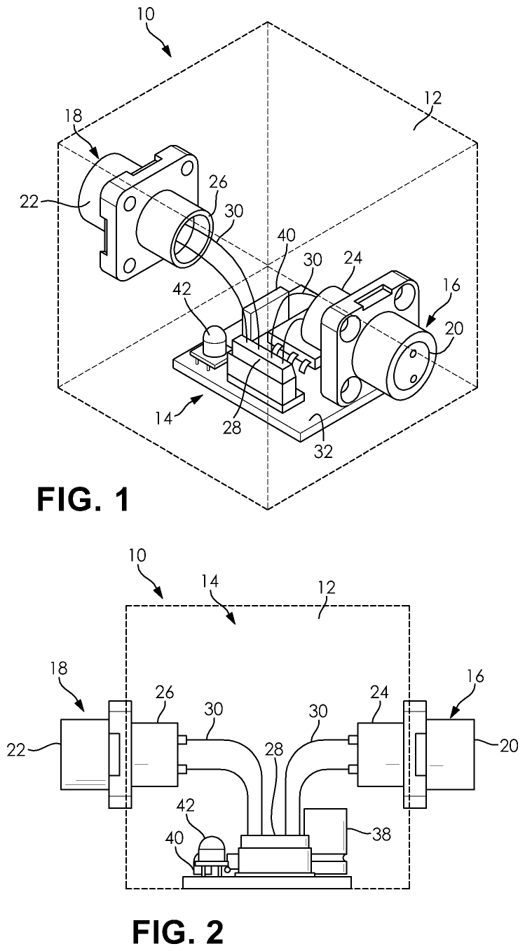

FIGS. 1-4 shows an apparatus 10 for controlling a joining process in accordance with an embodiment of the present disclosure. The apparatus 10 may include a casing 12 for housing a control assembly 14. The casing 12 may have any shape, size, and configuration and produced from any suitable material, as desired. In some embodiments, the control assembly 14 may include a first connector 16, a second connector 18, and a controller 20 in electrical communication with the connectors 16, 18. The first connector 16 may be in electrical communication with an electrical source and the second connector 18 may be in electrical communication with an electrical destination.

Each of the connectors 16, 18 may be at least partially disposed in opposing walls of the casing 12. A receptacle outer portion 20, 22 of the connectors 16, 18, respectively, may extend outwardly from the casing 12. An inner portion 24, 26 of the connectors 16, 18, respectively, may extend inwardly into a hollow interior of the casing 12. In certain embodiments, the inner portions 24, 26 of the connectors 16, 18 are in electrical communication with an adapter 28, via at least one wire 30. The adapter 28 may be configured to electrically connect the connectors 16, 18 to the controller 20.

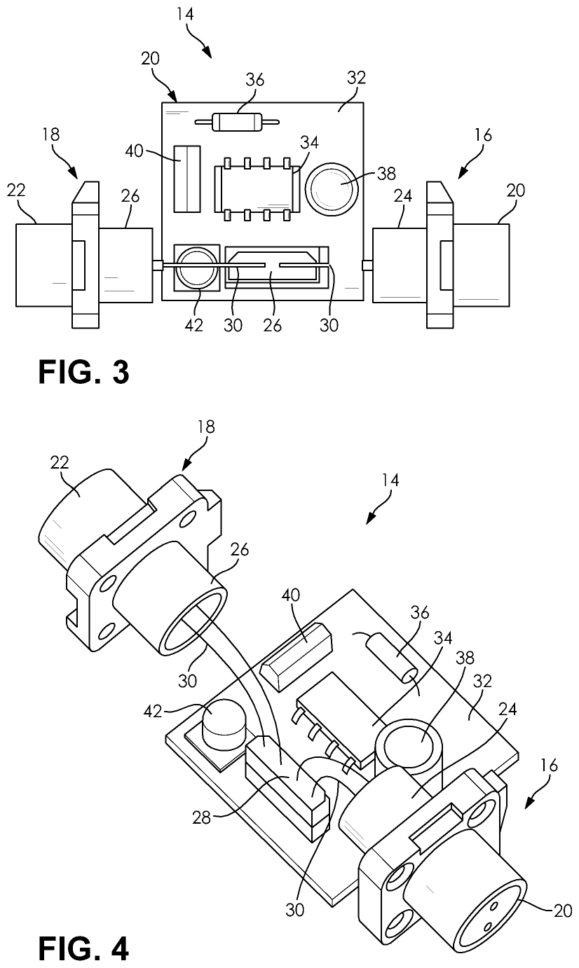

As best seen in FIG. 3, the controller 20 may comprise various electrical components, including but not limited to, a circuit board 32, one or more processors 34, one or more resistors 36, one or more capacitors 38, a memory 40, one or more receivers (not depicted), one or more storage devices (not depicted), and/or one or more indicators 42. In some embodiments, the processor 34 may be in communication with the memory 40 having executable instructions (e.g., software and/or firmware). It is understood that the controller 20 may include more or less circuitry and electrical components as needed.

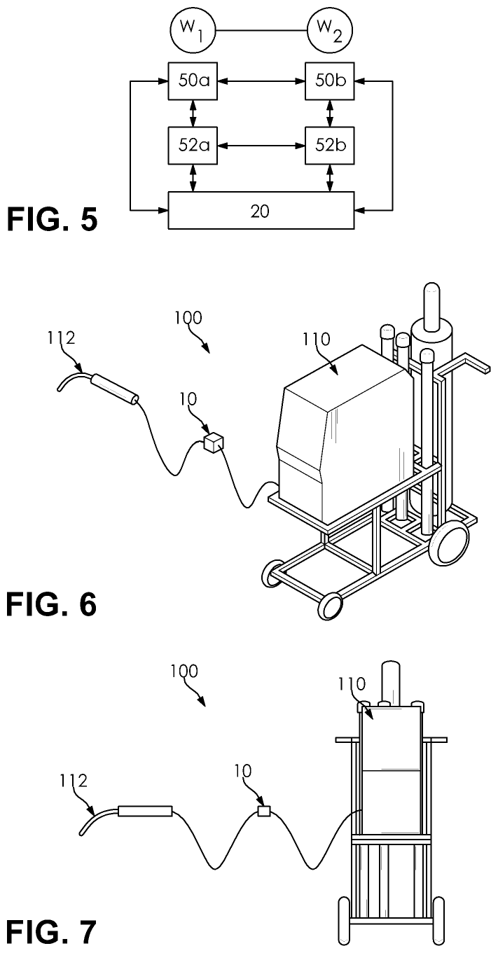

The controller 20 may be configured to perform as a switch and/or receive (e.g., either wired or wirelessly), via the one or more receivers, one or more signals from at least one source indicative of a state (i.e., property and/or characteristic) of a plurality of workpieces W₁, W₂, . . . Wn to be joined together. In certain embodiments, the controller 20 may be in communication with one or more sensors 50 and/or one or more transmitters 52. The one or more sensors 50 and/or the one or more transmitters 52 may be configured to provide data (e.g., image data, sensed data, and the like, etc.) to the controller 20. Furthermore, the one or more sensors 50 may be configured to receive data (e.g., configuration data, setup data, commands, register settings, etc.) from the controller 20 or any other computing device. The one or more sensors 50 and the one or more transmitters 52 may be in communication with each other in any combination. In some embodiments, the one or more sensors 50 may be configured to detect a correctness and/or acceptability of the workpieces W₁, W₂, . . . Wn and generate one or more signals indicative of the state of each of the workpieces W₁, W₂, . . . Wn. For example, as shown in FIG. 5, the controller 20 may be configured to receive a first signal, via a first transmitter 52a, from a first sensor 50a and/or a second signal, via a second transmitter 52b, from a second sensor 50b, each of which is analyzed by the processor 34 to determine that a first workpiece W₁ and/or a second workpiece W₂ is either acceptable or unacceptable. As another example, the controller 20 may be configured to receive, via the one or more transmitters 52a, 52b, a single signal from the one or more sensors 50a, 50b, which is analyzed by the processor 34 to determine that both the workpieces W₁, W₂ are acceptable. It is understood that the controller 20 may be configured to receive, via the one or more transmitters 52, as many signals from one or more sensors 50 as is workpieces W₁, W₂, . . . Wn to be joined.

In certain embodiments, the controller 20 using the processor 34 may generate an alert (e.g., activate the indicator 42) to notify an operator that at least one of the workpieces W₁, W₂, . . . Wn to be joined is not correct and/or unacceptable. It should be appreciated that various other means may be employed to notify the operator that an error has occurred. For example, the apparatus 10 may be configured to produce an audible alarm. Accordingly, the apparatus 10 minimizes a risk of joining incorrect and/or unacceptable workpieces W₁, W₂, . . . Wn and the repair and rework associated therewith, thereby maximizing efficiency and productivity.

Now turning to FIGS. 6 and 7, the apparatus 10 may be incorporated and used with a joining system 100. In a preferred embodiment, the joining system 100 is a gas metal arc welding system (i.e., a metal inert gas (MIG) welding system, a tungsten inert gas (TIG) welding system, etc.). In some instances, the joining system 100 may be portable. It should be appreciated, however, that the apparatus 10 may be incorporated and used with various other joining systems as desired. For example, the apparatus 10 may be used with other types of welding systems, brazing systems, soldering systems, and the like.

In certain embodiments, the joining system 100 may include an electrical source 110 for supply a flow of electrical current, an electrical destination 112 in electrical communication, via an electrical path, with the electrical source 110, and the apparatus 10 disposed in the electrical path. The apparatus 10 may perform as a switch (i.e., a lockout mechanism) to control a flow of electrical current through the electrical path from the electrical source 110 to the electrical destination 112. As illustrated, the electrical source 110 may be a generator and the electrical destination 112 may be a working tool (i.e. a welding torch) of the joining system 100. The apparatus 10 may be configured to selectively operate in a “closed” first mode and an “open” second mode. In the “closed” first mode of the apparatus 10, there is continuity across the connectors 16, 18 and the flow of the electrical current through the electrical path from the electrical source 110 to the electrical destination 112 is permitted. As such, the joining system 100 is enabled and operational when the apparatus 10 is in the first mode, resulting in a joining together of the workpieces W₁, W₂, . . . Wn.

Conversely, in the “open” second mode of the apparatus 10, there is an open circuit that disrupts a continuity across the connectors 16, 18 and prevents the flow of the electrical current through the electrical path from the electrical source 110 to the electrical destination 112. Thus, the joining system 100 is disabled and non-operational when the apparatus 10 is in the second mode.

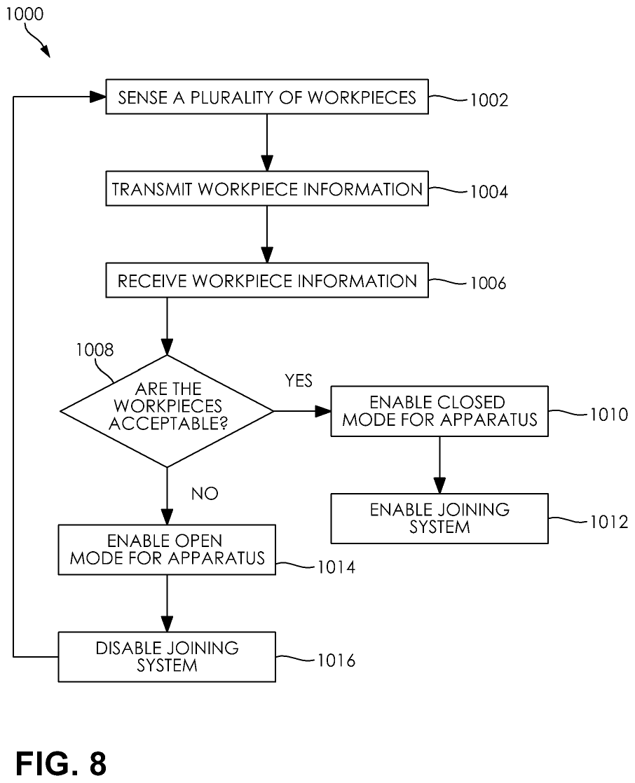

FIG. 8 is a flow diagram representing a method 1000 that may be employed by the apparatus 10 in accordance with an embodiment of the present disclosure. At step 1002, a plurality of workpieces W₁, W₂, . . . Wn are sensed by the one or more sensors 50 to detect a correctness and/or acceptability of the workpieces (i.e., workpiece information) and generate one or more signals indicative of the workpiece information. The one or more signals indicative of the workpiece information are then transmitted, via the one or more transmitters 52, to the apparatus 10 at step 1004 and received by processor 34 of the controller 20 at step 1006. At step 1008, the processor 34 of the controller 20 determines whether the workpieces W₁, W₂, . . . Wn are acceptable. If each of the workpieces W₁, W₂, . . . Wn is acceptable, the “closed” first mode of the apparatus 10 is enabled, and thereby, in some embodiments, the joining system 100 is also enabled.

If one or more of the workpieces W₁, W₂, . . . Wn is unacceptable, the “open” second mode of the apparatus 10 is enabled at step 1014, and the joining system 100 is disabled or “locked out” at step 1016, thus preventing the joining together of the workpieces W₁, W₂, . . . Wn. The apparatus 10 may then notify the operator that as error has occurred such as activating the indicator 42, for example. In such a way, the apparatus 10 may substantially reduce or prevent the likelihood that an incorrect and/or unacceptable workpiece W₁, W₂, . . . Wn is utilized. It is understood that the method 1000 may then be repeated as necessary.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions and methods may be made within the scope of the present technology, with substantially similar results.

What is claimed is:

1. An apparatus for controlling a joining process, comprising:
a casing; and
a control assembly disposed in the casing, wherein the control assembly includes a controller in communication with at least one sensor configured to sense at least one workpiece, wherein the controller is configured to selectively control a joining system based upon at least one workpiece.

2. The apparatus of claim 1, wherein the apparatus is in a first mode and the joining system is enabled when the at least one workpiece is acceptable and is in a second mode and the joining system is disabled when the at least one workpiece is unacceptable.

3. The apparatus of claim 1, wherein the joining system is a gas metal arc welding system.

4. The apparatus of claim 1, wherein the joining system is a portable.

5. The apparatus of claim 1, wherein the control assembly further includes a first connector and a second connector, the first connector in electrical communication with the controller and an electrical source and the second connector in electrical communication with the controller and an electrical destination.

6. The apparatus of claim 1, wherein the controller is configured to generate an alert when the at least one workpiece is unacceptable.

7. The apparatus of claim 1, wherein the controller includes at least one processor, the processor configured to receive at least one signal representative of the at least one workpiece.

8. The apparatus of claim 7, wherein the at least one signal is transmitted to the at least one processor by at least one transmitter in communication with the at least one sensor.

9. The apparatus of claim 7, wherein the processor determines an acceptability of the at least one workpiece.

10. A method for controlling a joining process, comprising:
providing an apparatus including a casing and a control assembly, wherein the control assembly is in communication with at least one sensor and at least one transmitter;
sensing, via the at least one sensor, at least one workpiece;
transmitting, via the at least one transmitter, at least one signal representative of the at least one workpiece;
receiving the at least one signal from the at least one sensor;
determining an acceptability of the at least one workpiece; and
selectively controlling a joining system based upon the acceptability of the at least one workpiece.

11. The method of claim 10, wherein the apparatus is in a first mode and the joining system is enabled when the at least one workpiece is acceptable and is in a second mode and the joining system is disabled when the at least one workpiece is unacceptable.

12. The method of claim 10, wherein the joining system is a gas metal arc welding system.

13. The method of claim 10, wherein the joining system is a portable.

14. The method of claim 10, wherein the control assembly further includes a first connector and a second connector, the first connector in electrical communication with the controller and an electrical source and the second connector in electrical communication with the controller and an electrical destination.

15. The method of claim 10, wherein the controller is configured to generate an alert when the at least one workpiece is unacceptable.

16. The method of claim 10, wherein the controller includes at least one processor, the processor configured to receive the at least one signal representative of the at least one workpiece.

17. The method of claim 16, wherein the at least one signal is transmitted to the at least one processor by at least one transmitter in communication with the at least one sensor.

18. The method of claim 16, wherein the processor determines the acceptability of the at least one workpiece.

19. A method of controlling a joining of workpieces, comprising:
providing an apparatus for controlling a gas metal arc welding system; and
selectively enabling and/or disabling the gas metal arc welding system using the apparatus, wherein the apparatus is configured to determine whether the workpieces are acceptable before the joining of the workpieces.

20. The method of claim 19, further comprising generating an alert when at least one of the workpieces is unacceptable.
